(19) United States
(12) Patent Application Publication
(10) Pub. No.: US 2024/0048090 A1
(43) Pub. Date: Feb. 8, 2024

(54) REINFORCED PILE FOR SOLAR FOUNDATIONS

(71) Applicant: Nextracker LLC, Fremont, CA (US)

(72) Inventors: Daniel Y. Abraham, Oakland, CA (US); Ricardo Delgado-Nanez, San Jose, CA (US); Alex Roedel, Oakland, CA (US)

(21) Appl. No.: 18/363,137

(22) Filed: Aug. 1, 2023

Related U.S. Application Data
(60) Provisional application No. 63/395,053, filed on Aug. 4, 2022.

(51) Int. Cl. H02S 20/32

(52) U.S. Cl. CPC H02S 20/32; H02S 20/10

(57) ABSTRACT

A solar tracking system includes a beam assembly having a beam including a pair of spaced apart flanges and a web interposed between each of the pair of spaced apart flanges and a reinforcement plate selectively coupled to a portion of the beam, the reinforcement plate configured to selectively strengthen a portion of the beam, and a bearing housing assembly selectively couplable to a portion of the beam.

### RELATED MATTERS

This application claims the benefit of U.S. Provisional Patent Application No. 63/395,053, filed Aug. 4, 2022, the contents of which are incorporated herein by reference in their entirety.

### BACKGROUND

### Technical Field

The present disclosure relates to solar power generation systems, and more particularly, to support structures for solar arrays within a solar tracking system.

### Background of Related Art

Solar tracking system utilize a tremendous amount of material in their construction, not least of which is the support structures on which the solar modules are mounted. As can be appreciated, the cost associated with the construction of the support structures can be extraordinarily high given the amount of piles, piers, frames, etc. required to support hundreds if not thousands of solar modules in a typical solar tracking system installation. In view of these costs, designers often seek to minimize the amount of material required to adequately support solar modules. However, reducing the amount of material used, by reducing the thickness of the material or changing the shape of the beam, often results in reduced strength in one or more directions, reducing the overall effectiveness of the beam resulting in failure or a need to increase the number of beams used to provide the desired strength. In view of these shortcomings, beam designs that utilize less material but provide the necessary strength and stability are desired.

### SUMMARY

In accordance with an aspect of the present disclosure, a solar tracking system includes a beam assembly having a beam including a pair of spaced apart flanges and a web interposed between each of the pair of spaced apart flanges, and a reinforcement plate selectively coupled to a portion of the beam, the reinforcement plate configured to selectively strengthen a portion of the beam, and a bearing housing assembly selectively couplable to a portion of the beam.

In aspects, a first end portion of the reinforcement plate may include a V-shaped profile.

In other aspects, a first end portion of the reinforcement plate may include a blunt profile.

In certain aspects, a first end portion of the reinforcement plate may include a first configuration and a second end portion of the reinforcement plate may include a second configuration that is different than the first configuration.

In other aspects, a first end portion and an opposite second end portion of the reinforcement plate may include the same configuration.

In aspects, the reinforcement plate may be selectively coupled to a portion of the beam that is at least partially embedded within the earth.

In certain aspects, the beam assembly may include a second reinforcement plate selectively coupled to a second portion of the beam, the second reinforcement plate configured to selectively strengthen a second portion of the beam.

In other aspects, a thickness of the reinforcement plate may be different than a thickness of the second reinforcement plate.

In aspects, the second reinforcement plate may be selectively coupled to a second portion of the beam that is longitudinally offset relative to the reinforcement plate.

In other aspects, the solar tracking system may include a second beam assembly including a second beam including a pair of spaced apart flanges and a web interposed between each of the pair of spaced apart flanges and a second reinforcement plate selectively coupled to a portion of the second beam, the second reinforcement plate configured to selectively strengthen a portion of the second beam.

In certain aspects, the solar tracking system may include a slew drive selectively couplable to a portion of the second beam assembly.

In accordance with another aspect of the present disclosure, a solar tracking system includes a first beam assembly including a first beam including a pair of spaced apart flanges and a web interposed between each of the pair of spaced apart flanges and a reinforcement plate selectively coupled to a portion of the first beam, the reinforcement plate configured to selectively strengthen a portion of the first beam, a second beam assembly including a second beam including a pair of spaced apart flanges and a web interposed between each of the pair of spaced apart flanges, and a bearing housing assembly selectively couplable to a portion of the first beam.

In aspects, the second beam assembly may include a second reinforcement plate selectively coupled to a portion of the second beam, the second reinforcement plate configured to selectively strengthen a portion of the second beam.

In other aspects, a thickness of the reinforcement plate of the first beam assembly may be different than a thickness of the second reinforcement plate.

In certain aspects, a first end portion of the reinforcement plate includes a V-shaped profile.

In accordance with another aspect of the present disclosure, a method of installing a solar tracking system includes determining if a beam of the solar tracking system needs reinforcement, identifying a portion of the beam that needs to be reinforced, coupling a first reinforcement plate to the identified portion of the beam to form a reinforced beam, driving the reinforced beam into the earth, and selectively coupling a bearing housing assembly to a portion of the reinforced beam.

In aspects, the method may include coupling a second reinforcement plate to a second portion of the reinforced beam.

In certain aspects, coupling the second reinforcement plate to the second portion of the reinforced beam may include the second reinforcement plate having a thickness that is different from a thickness of the first reinforcement plate.

In other aspects, coupling the second reinforcement plate to the second portion of the reinforced beam may include coupling the second reinforcement plate to a second portion of the reinforced beam that is longitudinally offset from the first reinforcement plate.

In aspects, driving the reinforced beam into the earth may include driving the reinforced beam and a portion of the first reinforcement plate into the earth.

### BRIEF DESCRIPTION OF THE DRAWINGS

Various aspects and features of the present disclosure are described hereinbelow with reference to the drawings, wherein:

FIG. 1 is a perspective view of a beam assembly provided in accordance with the present disclosure;

FIG. 2 is an exploded view of the beam assembly of FIG. 1;

FIG. 3 is a perspective view of a reinforcement plate of the beam assembly of FIG. 1;

FIG. 4 is a perspective view of the beam assembly of FIG. 1 shown driven into earth;

FIG. 5 is a perspective view of a solar tracking system using the beam assembly of FIG. 1; and

FIG. 6 is a flow diagram of a method of installing a solar tracking system provided in accordance with the present disclosure.

### DETAILED DESCRIPTION

The present disclosure is directed to a pier or beam for use with a solar tracking system. The beam is generally a wide-flange beam (W-beam) having a pair of parallel flanges and a web interposed therebetween to form a generally I-shaped configuration. The beam includes a flange thickness that can be selectively increased at selected portions by securing or otherwise coupling a reinforcement plate to one or both flanges of the beam. In this manner, the strength of the beam at a specific location can be increased without having to increase the overall thickness of the entire beam, thereby reducing the amount of material used to form the beam, reducing the weight of the beam, and reducing costs associated with manufacturing the beam.

The reinforcement plate includes a generally planar profile extending along a longitudinal axis. The reinforcement plate includes a rectangular profile and is generally complimentary to the configuration of the flange of the beam. One end portion of the reinforcement plate includes a generally V-shaped configuration defining an apex or point to enable the reinforcement plate to more easily be driven into the ground as apposed to a blunt profile. The reinforcement plate includes a plurality of bores defined therethrough to enable the reinforcement plate to be bolted or otherwise coupled to the beam in the field or during installation of the beam. These and other aspects of the present disclosure will be described in further detail herein.

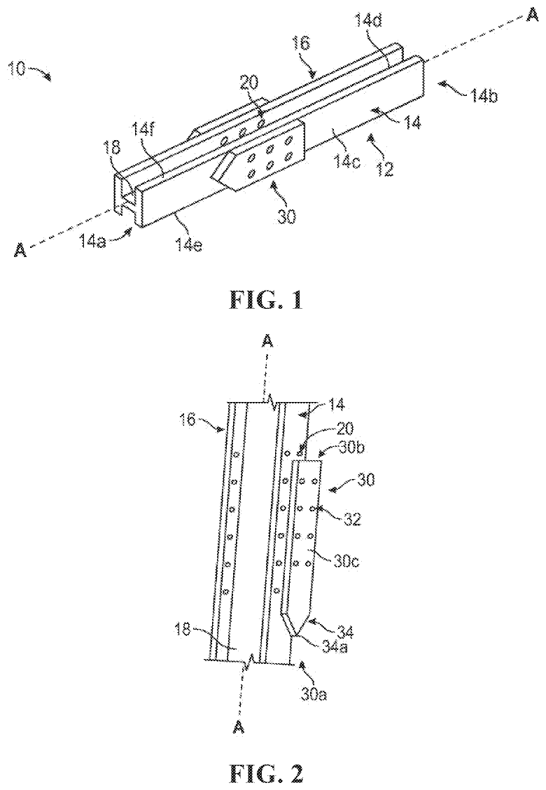

Referring now to the drawings, a pier or beam assembly provided in accordance with the present disclosure is illustrated in FIGS. 1 and 2 and generally identified by reference numeral 10. The beam assembly 10 includes a beam 12 and one or more reinforcement plates 30 that are selectively couplable to one or more portions of the beam, as will be described in further detail hereinbelow.

The beam 12 includes a generally I-shaped configuration (e.g., a W-beam) having a pair of first and second parallel flanges 14 and 16, respectively, and a web 18 interposed between each of the first and second parallel flanges 14, 16. Although generally illustrated as being formed as a unitary component, it is envisioned that the beam 12 may be formed from one or more components coupled to one another via welding, fasteners, adhesives, amongst others.

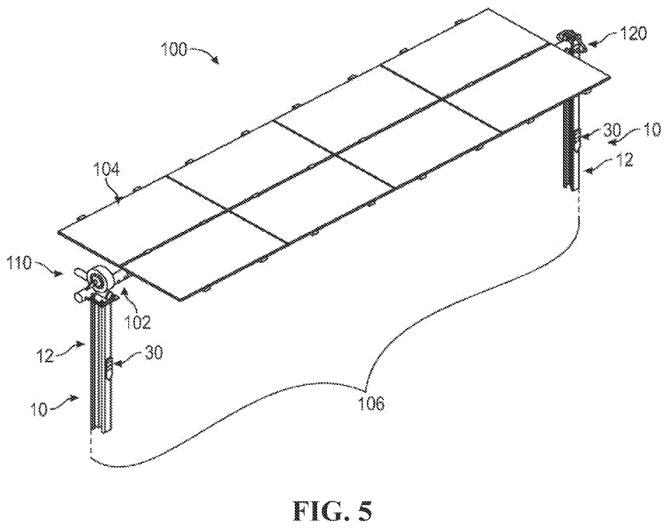

Each of the pair of first and second parallel flanges 14, 16 is substantially similar and therefore only one flange 14 of the pair of first and second parallel flanges 14, 16 will be described herein in the interest of brevity. The flange 14 defines a generally rectangular profile extending along a longitudinal axis A-A between opposed first and second end portions 14a and 14b, respectively. The flange 14 includes opposed top and bottom surfaces 14c and 14d, respectively, extending between the opposed first and second end portions 14a, 14b and opposed first and second side portions 14e and 14f, respectively. The first end portion 14a of the flange 14 is configured to be driven or otherwise advanced within the earth or soil and the second end portion 14b is configured to be coupled or otherwise secured to a portion of a bearing housing assembly (BHA) 120 or a portion of a slew drive 110 of a solar tracking system 100, as will be described in further detail hereinbelow (FIG. 5).

The flange 14 includes a plurality of bores 20 defined through the top and bottom surfaces that are configured to receive a corresponding fastener therethrough to selectively couple a reinforcement plate 30 thereto, as will be described in further detail hereinbelow. The plurality of bores 20 is defined on the flange 14 at a position that generally corresponds to a portion of the beam 10 that is even with a surface of the earth or soil in which the beam assembly 10 is installed. As can be appreciated, the plurality of bores 20 may include bores that are disposed within the earth or soil (e.g., below grade) and bores that are exposed (e.g., above grade) such that the reinforcement plate 30 may be partially embedded within the earth (FIG. 4). Although generally described as having a portion of the plurality of bores 20 positioned such that a portion of the reinforcement plate 30 is embedded within the earth, it is envisioned that the plurality of bores 20 may be disposed on the flange 14 such that the reinforcement plate 30 is entirely embedded within the earth (e.g., below grade) or entirely exposed (e.g., above grade), depending upon the design needs of the beam assembly 10.

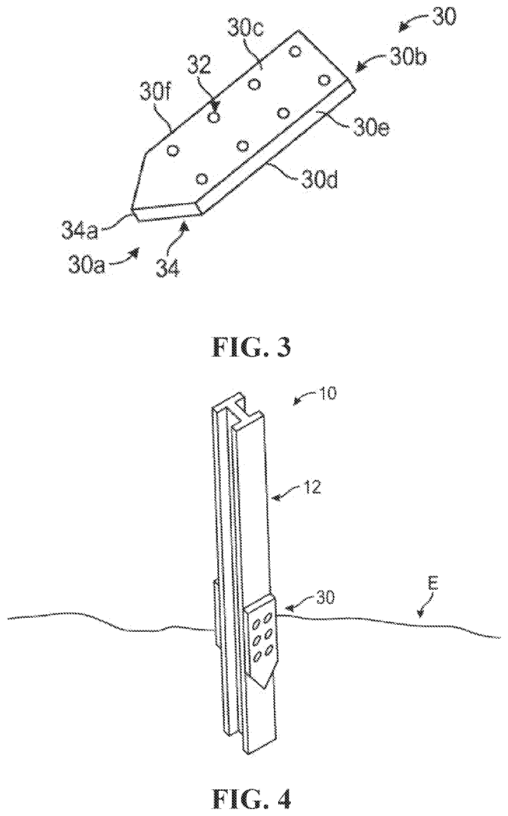

Continuing with FIGS. 1 and 2, and with additional reference to FIGS. 3 and 4, the reinforcement plate 30 defines a generally rectangular profile extending between first and second end portions 30a and 30b, respectively. The reinforcement plate 30 includes top and bottom surfaces 30c and 30d, respectively, extending between the first and second end portions 30a, 30b and opposed first and second side surfaces 30e and 30f, respectively. The reinforcement plate 30 includes a width that is substantially similar to a width of the pair of first and second parallel flanges 14, 16 of the beam 12, although it is envisioned that the reinforcement plate 30 may include any suitable width, such as narrower or wider than the width of the pair of first and second parallel flanges 14, 16, depending upon the design needs of the beam assembly 10. The reinforcement plate includes a plurality of holes 32 defined through the top and bottom surfaces 30c, 30d that generally correspond to one or more of the plurality of bores 20 of the flanges 14, 16 of the beam 12. It is envisioned that the reinforcement plate 30 may be selectively coupled or fixedly coupled to a respective flange of the pair of first and second parallel flanges 14, 16 using any suitable means, such as fasteners, adhesives, welding, amongst others. In one non-limiting embodiment, the reinforcement plate 30 is coupled to the flange 14 via one or more bolts and nuts (not shown).

The first end portion 30a of the reinforcement plate 30 includes a generally V-shaped profile 34 defining an apex or point 34a. As can be appreciated, the V-shaped profile 34 and the apex 34a cooperate to enable the reinforcement plate 30 to more easily penetrate the earth or soil as the beam assembly 10 is driven or otherwise caused to be embedded in the earth (FIG. 4). Although generally described as being a V-shaped profile, it is envisioned that the first end portion may include any suitable profile that enables the reinforcement plate 30 to be more easily driven into the earth, such as a blunt profile, an arcuate profile, amongst others. Although only the first end portion 30a of the reinforcement plate 30 is described as having a V-shaped profile 34, it is envisioned that both the first and second end portions 30a, 30b of the reinforcement plate 30 may include the same or different profile to one another, depending upon the design needs of the beam assembly 10.

The reinforcement plate 30 includes a length (e.g., extending between the first and second end portions 30a, 30b) that is generally less than a length of the beam 12. In this manner, the reinforcement plate 30 stiffens a portion of the beam 12 at a location where the loads imparted on the beam 12 are highest. As can be appreciated, the overall length of the reinforcement plate 30 may be tailored to a specific loading, and in embodiments, a length of a reinforcement plate 30 coupled to the flange 14 may be the same or different than a reinforcement plate 30 coupled to the flange 16. In embodiments, only one reinforcement plate 30 may be coupled to the beam 12, depending upon the design needs of the beam assembly 10.

Turning to FIG. 5, a solar tracking system utilizing one or more beam assemblies 10 is illustrated and generally identified by reference numeral 100. The solar tracking system 100 includes a plurality beam assemblies 10 disposed in spaced relation to one another and embedded in the earth. A torque tube 102 extends between each adjacent beam assembly 10 and is rotatably supported on each beam assembly 10. The solar tracking system 100 includes a plurality of solar panels 104 supported on the torque tube 102. The span between two adjacent beam assemblies 10 is referred to as a bay 106 and may be generally in the range of about 8 meters in length. A plurality of solar trackers may be arranged in a north-south longitudinal orientation to form a solar array.

The solar tracking system 100 includes at least one slew drive 110 operably coupled to the torque tube 102 and supported on a respective beam assembly of the plurality of beam assemblies 10. The slew drive 110 effectuates rotation of the torque tube 102, which effectuates a corresponding rotation of the solar panels 104 to track the location of the sun. The solar tracking system 100 includes at least one bearing housing assembly (BHA) 120 disposed on a respective beam assembly of the plurality of beam assemblies 10. The bearing housing assembly 120 is operably coupled to the torque tube 102 to rotatably support the torque tube 102 therein as the torque tube 102 is caused to be rotated by the slew drive 110. Those having ordinary skill in the art will recognize that the slew drive assembly 110 and the bearing housing assembly 112 are illustrative of any suitable drive or bearing housing assembly suitable for use with a solar tracking system, and therefore, the present disclosure should not be considered limited to the slew drive assembly 110 and/or bearing housing assembly 120 described herein.

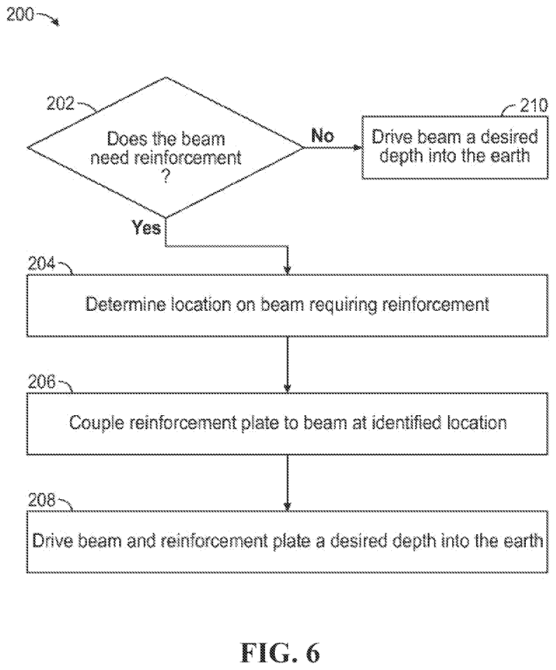

With reference to FIG. 6, a method of installing a solar tracking system is illustrated and generally identified by reference numeral 200. Initially, in step 202, it is determined if a beam 12 needs to be reinforced. If it is determined that the beam 12 does need to be reinforced, a location where the beam 12 must be reinforced is identified in step 204. In step 206, a reinforcement plate 20 is coupled to the beam 12 at the identified location. At this point, the beam assembly 10, including the beam 12 and the reinforcement plate 20 coupled thereto, is driven into the earth at a desired location in step 208. If the beam 12 does not need to be reinforced, in step 210, the beam 12 is driven into the earth at a desired location to a desired depth. As can be appreciated, the method described hereinabove may be repeated as many times as necessary depending upon the number of reinforcement plates required to adequately strengthen the beam 12 and/or the number of beams 12 and/or beam assemblies 10 required for installation of the solar tracking system.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

What is claimed is:

1. A solar tracking system, comprising:
a beam assembly, including:
a beam including a pair of spaced apart flanges and a web interposed between each of the pair of spaced apart flanges; and
a first reinforcement plate selectively coupled to a portion of the beam, the reinforcement plate configured to selectively strengthen a portion of the beam; and
a bearing housing assembly selectively couplable to a portion of the beam.

2. The solar tracking system according to claim 1, wherein a first end portion of the reinforcement plate includes a V-shaped profile.

3. The solar tracking system according to claim 1, wherein a first end portion of the reinforcement plate includes a blunt profile.

4. The solar tracking system according to claim 1, wherein a first end portion of the reinforcement plate includes a first configuration and a second end portion of the reinforcement plate includes a second configuration that is different than the first configuration.

5. The solar tracking system according to claim 1, wherein a first end portion and an opposite second end portion of the reinforcement plate include the same configuration.

6. The solar tracking system according to claim 1, wherein the reinforcement plate is selectively coupled to a portion of the beam that is at least partially embedded within the earth.

7. The solar tracking system according to claim 1, wherein the beam assembly includes a second reinforcement plate selectively coupled to a second portion of the beam, the second reinforcement plate configured to selectively strengthen a second portion of the beam.

8. The solar tracking system according to claim 7, wherein a thickness of the reinforcement plate is different than a thickness of the second reinforcement plate.

9. The solar tracking system according to claim 7, wherein the second reinforcement plate is selectively coupled to a second portion of the beam that is longitudinally offset relative to the reinforcement plate.

10. The solar tracking system according to claim 1, further comprising a second beam assembly, the second beam assembly including:
a second beam including a pair of spaced apart flanges and a web interposed between each of the pair of spaced apart flanges; and
a second reinforcement plate selectively coupled to a portion of the second beam, the second reinforcement plate configured to selectively strengthen a portion of the second beam.

11. The solar tracking system according to claim 10, further comprising a slew drive selectively couplable to a portion of the second beam assembly.

12. A solar tracking system, comprising:
a first beam assembly, including:
a first beam including a pair of spaced apart flanges and a web interposed between each of the pair of spaced apart flanges; and
a reinforcement plate selectively coupled to a portion of the first beam, the reinforcement plate configured to selectively strengthen a portion of the first beam;
a second beam assembly including a second beam including a pair of spaced apart flanges and a web interposed between each of the pair of spaced apart flanges; and
a bearing housing assembly selectively couplable to a portion of the first beam.

13. The solar tracking system according to claim 12, wherein the second beam assembly includes a second reinforcement plate selectively coupled to a portion of the second beam, the second reinforcement plate configured to selectively strengthen a portion of the second beam.

14. The solar tracking system according to claim 13, wherein a thickness of the reinforcement plate of the first beam assembly is different than a thickness of the second reinforcement plate.

15. The solar tracking system according to claim 12, wherein a first end portion of the reinforcement plate includes a V-shaped profile.

16. A method of installing a solar tracking system, comprising:
determining if a beam of the solar tracking system needs reinforcement;
identifying a portion of the beam that needs to be reinforced;
coupling a first reinforcement plate to the identified portion of the beam to form a reinforced beam;
driving the reinforced beam into the earth; and
selectively coupling a bearing housing assembly to a portion of the reinforced beam.

17. The method according to claim 16, further comprising coupling a second reinforcement plate to a second portion of the reinforced beam.

18. The method according to claim 17, wherein coupling the second reinforcement plate to the second portion of the reinforced beam includes the second reinforcement plate having a thickness that is different from a thickness of the first reinforcement plate.

19. The method according to claim 17, wherein coupling the second reinforcement plate to the second portion of the reinforced beam includes coupling the second reinforcement plate to a second portion of the reinforced beam that is longitudinally offset from the first reinforcement plate.

20. The method according to claim 16, wherein driving the reinforced beam into the earth includes driving the reinforced beam and a portion of the first reinforcement plate into the earth.
